(19) United States
(12) Patent Application Publication
(10) Pub. No.: US 2025/0079487 A1
(43) Pub. Date: Mar. 6, 2025

(54) SYSTEM AND METHOD FOR OPERATING A FUEL CELL

(71) Applicant: GM GLOBAL TECHNOLOGY OPERATIONS LLC, Detroit, MI (US)

(72) Inventors: Biju Edamana, Christiansburg, VA (US); Manish Sinha, St. Petersburg, FL (US); Venkatesh Venkadasamy, Novi, MI (US); William H. Pettit, Rochester, NY (US); Rodney J. Rhodes, Davisburg, MI (US)

(73) Assignee: GM GLOBAL TECHNOLOGY OPERATIONS LLC, Detroit, MI (US)

(21) Appl. No.: 18/459,598

(22) Filed: Sep. 1, 2023

(51) Int. Cl. H01M 8/04537; H01M 8/04858

(52) U.S. Cl. CPC H01M 8/04619; H01M 8/04626; H01M 8/0494; H01M 2250/20

(57) ABSTRACT

A hybrid system including a high-voltage bus, a high-voltage battery electrically connected to the high-voltage bus, a fuel cell power device electrically connected to the high-voltage bus, and a drive unit electrically connected to the high-voltage bus. A controller is electrically connected to the drive unit, the fuel cell power device, and the high-voltage battery. The controller is configured to identify an application power request for the drive unit and determine a relationship between the application power request and an optimal membrane life power for the fuel cell power device. The controller is also configured to direct the fuel cell power device to operate between the optimal membrane life power and a second power. The application power request is at a power level between the optimal membrane life power and the second power.

### INTRODUCTION

A fuel cell is an electrochemical device that converts chemical energy of a fuel, e.g., hydrogen, into electrical power by an electro-chemical reaction. Multiple fuel cells may be combined to form a fuel cell stack to generate a desired fuel cell power output. One type of fuel cell includes a polymer electrolyte membrane fuel cell (PEMFC). The electric power generated by a fuel cell stack may be used to power an electric machine, such as an on-vehicle traction motor or a stationary generator or battery charger.

### SUMMARY

Disclosed herein is a hybrid system. The hybrid system includes a high-voltage bus, a high-voltage battery electrically connected to the high-voltage bus, a fuel cell power device electrically connected to the high-voltage bus, and a drive unit electrically connected to the high-voltage bus. A controller is electrically connected to the drive unit, the fuel cell power device, and the high-voltage battery. The controller is configured to identify an application power request for the drive unit and determine a relationship between the application power request and an optimal membrane life power for the fuel cell power device. The controller is also configured to direct the fuel cell power device to operate between a first power associated with the optimal membrane life power and a second power. The application power request is at a power level between the optimal membrane life power and the second power.

Another aspect of the disclosure may be where the first power is withing a predetermined range that includes the optimal membrane life power and the optimal membrane life power is determined based on a function of an electric power generated by the fuel cell power device and membrane lifetime energy of the fuel cell power device.

Another aspect of the disclosure may be where the optimal membrane life power corresponds to an optimal electric power that produces an optimal membrane lifetime energy.

Another aspect of the disclosure may be where the optimal membrane lifetime energy is determined based on a relationship between membrane life and the electric power.

Another aspect of the disclosure may be where the membrane lifetime energy is determined by multiplying the membrane life of the fuel cell power device by the electric power generated at the membrane life.

Another aspect of the disclosure may be where the relationship between the membrane lifetime energy and the electric power is based on a first relationship between a coolant temperature of the fuel cell power device and the electric power generated by the fuel cell power device and a second relationship between the membrane life of the fuel cell power device and the coolant temperature of the fuel cell power device.

Another aspect of the disclosure may be where the application power request is determined based on an average power usage for the hybrid system over a predetermined period of time.

Another aspect of the disclosure may be where the controller is configured to direct fuel cell output power to the high-voltage battery when operating at the optimal membrane life power with the application power request being less than the optimal membrane life power and the second power includes one of a minimum power generated or zero-power power generated by the fuel cell power device.

Another aspect of the disclosure may be where the controller is configured to direct fuel cell output power to the high-voltage battery when operating at the second power with the second power being greater than the application power request.

Disclosed herein is a method of operating a hybrid system. The method includes identifying an application power request for the hybrid system including a high-voltage battery, a fuel cell power device, and an electric drive unit each electrically connected to a high-voltage bus. A relationship is determined between the application power request and an optimal membrane life power for the fuel cell power device. The fuel cell power device is directed to operate between a first power associated with the optimal membrane life power and a second power, wherein application power request is at a power level between the optimal membrane life power and the second power.

Another aspect of the disclosure may be where the first power is withing a predetermined range that includes the optimal membrane life power and the optimal membrane life power is determined based on a function of an electric power generated by the fuel cell power device and a membrane lifetime energy of the fuel cell power device.

Another aspect of the disclosure may be where the optimal membrane life power corresponds to an optimal electric power that produces a maximum membrane life energy and the membrane lifetime energy is determined based on a relationship between the electric power and membrane life.

Another aspect of the disclosure may be where the application power request is analyzed over a period of time to determine when to operate between the optimal membrane life power and the second power.

Another aspect of the disclosure may include directing a fuel cell generated power to the high-voltage battery when the application power request is less than the optimal membrane life power and the second power includes one of a minimum power generated or zero-power power generated by the fuel cell power device.

Another aspect of the disclosure may include directing a fuel cell generated power to the high-voltage battery when the application power request is greater than the optimal membrane life power and the second power includes one of a minimum power generated or zero-power power generated by the fuel cell power device.

Another aspect of the disclosure may be where a time to operate between the optimal membrane life power and the second power is determined based on a battery capacity in relation to the application power request.

Another aspect of the disclosure may include charging the high-voltage battery with an external power source.

Disclosed herein is a method of operating a hybrid system. The method includes identifying an application power request for the hybrid system including a high-voltage battery, a fuel cell power device, and an electric drive unit each electrically connected to a high-voltage bus. A relationship is determined between the application power request and an optimal membrane life power for the fuel cell power device. The optimal membrane life power is determined based on a function of an electric power generated by the fuel cell power device and membrane lifetime energy of the fuel cell power device. The fuel cell power device is directed to operate between the optimal membrane life power and a second power. The application power request is at a power level between a first power associated with the optimal membrane life power and the second power. Excess power generated by the fuel cell power device is directed to the high-voltage battery.

Another aspect of the disclosure may be where a time to operate between the optimal membrane life power and the second power is determined based on a battery capacity in relation to the application power request.

### BRIEF DESCRIPTION OF THE DRAWINGS

One or more embodiments will now be described, by way of example, with reference to the accompanying drawings, in which:

FIG. 1 schematically illustrates elements of an architecture for a torque generating system that includes a fuel cell power device, a high-voltage battery an electric drive unit, and an associated controller, in accordance with the disclosure.

FIG. 2 graphically illustrates an example performance characterization of the fuel cell power device showing a non-linear relationship between an electric power and temperature.

FIG. 3 graphically illustrates another example performance characterization of the fuel cell power device showing a non-linear relationship between temperature and membrane life.

FIG. 4 graphically illustrates an approach for determining a third performance characterization and a fourth performance characterization of the fuel cell power device.

FIG. 5 graphically illustrates the third performance characterization and the fourth performance characterization of the fuel cell power device in separate non-linear relationships.

FIG. 6 illustrates a method of operating the fuel cell power device.

FIG. 7A graphically illustrates a power output of the fuel cell power device when an application power request is less than an optimal membrane life power.

FIG. 7B graphically illustrates a state of charge of the high-voltage battery in relation to the power output of the fuel cell power device of FIG. 7A.

FIG. 8A graphically illustrates the power output of the fuel cell power device when an application power request is greater than the optimal membrane life power.

FIG. 8B graphically illustrates a state of charge of the high-voltage battery in relation to the power output of the fuel cell power device of FIG. 8A.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The following detailed description is exemplary in nature and is not intended to limit the application and uses. Furthermore, there is no intent to be bound by any expressed or implied theory presented herein. Throughout the drawings, corresponding reference numerals indicate like or corresponding parts and features. As used herein, the term “system” refers to combinations or collections of mechanical and electrical hardware, software, firmware, electronic control component, processing logic, and/or processor device, individually or in combination, including without limitation: application specific integrated circuit (ASIC), an electronic circuit, a processor (shared, dedicated, or group) that executes one or more software or firmware programs, memory to contain software or firmware instructions, a combinational logic circuit, and/or other suitable components that provide the described functionality.

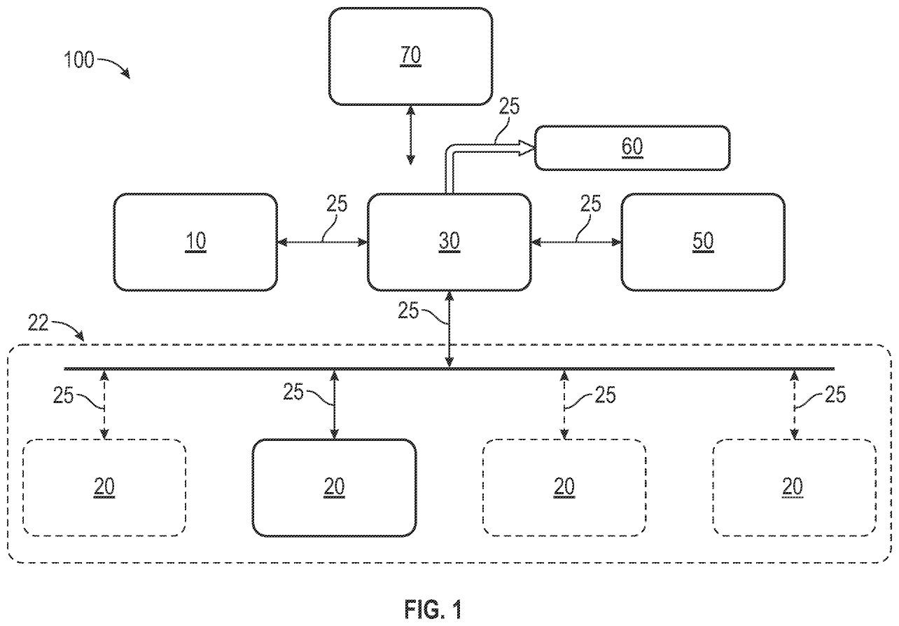

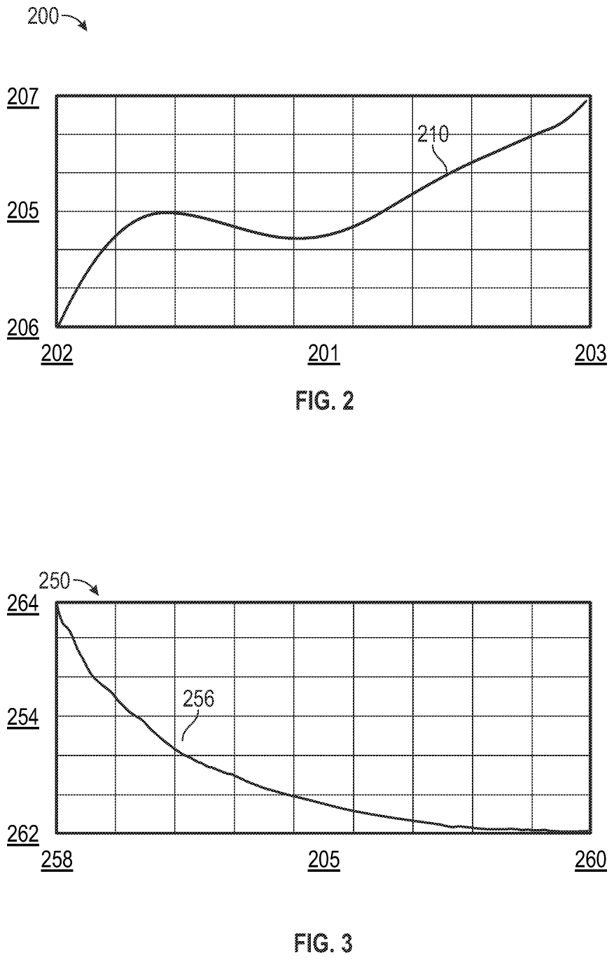

FIG. 1, consistent with embodiments disclosed herein, schematically illustrates elements of an architecture for a torque generating system 100 that includes a single one or an array 22 of fuel cell power device(s) 20, a high-voltage battery 10, an electric drive unit 50, an auxiliary power unit 60, and a controller 70. The torque generating system 100 is controllable to generate mechanical torque in response to a power request, wherein the power request may include, by way of non-limiting examples, an output torque request, an operator torque request, etc. The fuel cell power device(s) 20 and the high-voltage battery 10 are electrically connected to a high-voltage electric power distribution system 30 via a high-voltage bus 25 to supply electric power to the electric drive unit 50. The fuel cell power device(s) 20 and the high-voltage battery 10 may be employed as DC electric power sources for the electric drive unit 50. In one embodiment, the electric drive unit 50 may be an electric machine that may be employed on a mobile platform, i.e., a vehicle to provide tractive power, and may be in the form of a commercial vehicle, industrial vehicle, agricultural vehicle, passenger vehicle, aircraft, watercraft, rail-train, all-terrain vehicle, personal movement apparatus, robot and the like to accomplish the purposes of this disclosure. Alternatively, the electric drive unit 50 may be disposed on a non-vehicular application, such as for stationary power generation, portable power generation, electronics, a remote weather station operation, a communication center, etc. The single fuel cell power device 20 is indicated by solid lines, and the array 22 of the fuel cell power devices 20 is indicated by dashed lines. Details related to performance characterizations of the fuel cell power device(s) 20 are discussed with reference to FIGS. 2. Any quantity of the fuel cell power device(s) 20 may be employed based upon system-specific needs, including, e.g., two, three, four, or more of the fuel cell power device(s) 20. By way of a non-limiting example, as many as twenty or more of the fuel cell power devices 20 being employed is some embodiments, such as on a train locomotive.

In one embodiment, the fuel cell power device(s) 20 and the high-voltage battery 10 cooperate to supply electric power to the electric drive unit 50, with the controller 70 operating the torque generating system 100 with the high-voltage battery 10 in a charge-depletion mode over the course of a trip, such as when the torque generating system 100 is employed on-vehicle and employing route planning and navigation routines, such as user pattern learning, driver mode input, navigation route input, etc. In one embodiment, the fuel cell power device(s) 20 and the high-voltage battery 10 cooperate to supply electric power to the electric drive unit 50, with the controller 70 operating the torque generating system 100 with the high-voltage battery 10 in a charge-sustaining mode over the course of a trip when the torque generating system 100 is employed on-vehicle. The controller 70 may also be optimized for route changes and customer input as it operates through the charge-sustaining mode and the charge-depleting mode, or vice versa.

The electric drive unit 50 includes, in one embodiment, a rotary electric machine that serves as an electric traction motor for a system having an at least partially electric drivetrain and is coupled to a drive wheel via a driveline. Non-limiting examples of the rotary electric machine may include a permanent magnet direct current motor, an alternating current motor, a direct current generator, an alternating current generator, an eddy current clutch, an eddy current brake, a rotary converter, a hysteresis dynamometer, a transformer, and the like. Motor torque generated by the rotary electric machine may be used to propel a vehicle, and/or perform other electro-mechanical functions. The rotary electric machine may also be controlled to react torque and thus generate electric power, such as for regenerative braking. The electric drive unit 50 may include a single electric machine that connects via a driveline to a vehicle wheel when employed on-vehicle. Alternatively, the electric drive unit 50 may include multiple electric machines that connect via one or multiple driveline devices to multiple vehicle wheels.

Each fuel cell power device 20 includes a plurality of polymer electrolyte membrane fuel cell (PEMFC) in one embodiment, and includes a cathode, an anode, and an electrolyte. An anode system may include a single injector system or a multi-injector system that fluidly couples to the anode and is arranged to controllably supply pressurized hydrogen to an inlet of the anode from a hydrogen tank. Each fuel cell power device 20 may also include an air supply system that includes an air inlet and an exhaust outlet and is arranged to supply and control airflow to the cathode. The electrolyte, e.g., a polymer electrolyte membrane, is disposed between the cathode and the anode. Further, the fuel cell 20 may be formed from one or more membrane electrode assemblies (MEA) that include the cathode, anode, a plurality of flow plates, a catalyst, and a plurality of gas diffusion layers.

During operation of the fuel cell power device 20, chemical energy from an electrochemical reaction of hydrogen (H₂) and oxygen (O₂) may transform to electrical energy. In particular, hydrogen gas (H₂) may enter the anode and be catalytically split into protons (H⁺) and electrons (e⁻) at the catalyst. The protons (H⁺) may permeate through the electrolyte to the cathode, while the electrons (e⁻) may not permeate the electrolyte but may instead travel along an external load circuit to the cathode to produce a fuel cell power output or electrical current. Concurrently, air, e.g., oxygen (O₂) and nitrogen (N₂), may enter the cathode, react with the protons (H⁺) permeating through the electrolyte and the electrons (e⁻) arriving to the cathode from the external load circuit 50, and form a byproduct such as water (H₂O) and heat. The heat may be expelled through the exhaust of the fuel cell and/or a cooling fluid. The water (H₂O) may travel through the electrolyte to the anode and may be collected in a sump. Each fuel cell power device(s) 20 exhibits a non-linear power-temperature relationship, which is described with reference to FIG. 2.

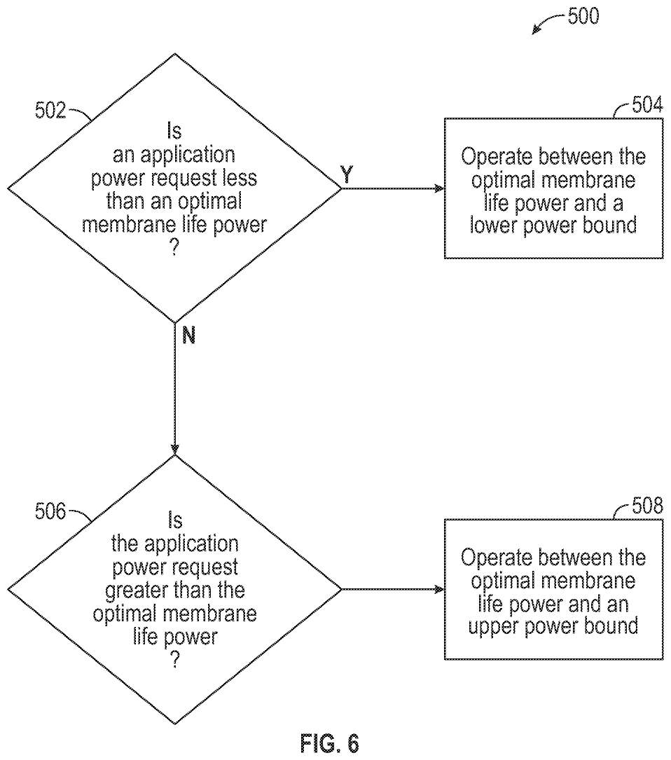

The controller 70 includes an executable control routine in method 500 for operating the torque generating system 100 and is described herein with reference to FIG. 6. The torque generating system 100 includes the high-voltage battery 10 and a single fuel cell power device 20 in one embodiment. Alternatively, the torque generating system 100 includes the high-voltage battery 10, the fuel cell power device 20, and a second of the fuel cell power devices 20 in one embodiment.

FIG. 2 graphically illustrates a performance characterization 200 for an embodiment of the fuel cell power device 20 that is described with reference to FIG. 1. The performance characterization 200 may be described in relation to electric power 201 on the horizontal axis and a temperature 205 of the fuel cell power device 20 on the vertical axis, with a non-linear power-temperature relationship 210 being illustrated. The non-linear power-temperature relationship 210 for the fuel cell power device 20 may occur as a result of system optimization, material selection, design trade-offs, etc. during product development that affect performance, durability, and robustness to achieve electric power targets.

The electric power 201 may be a quantitative measure of net electric power output from the fuel cell power device 20, and ranges between a minimum or zero power output 202 and a maximum power output 203. The maximum power output 203 indicates the maximum power output that the fuel cell power device 20 is capable of producing.

The temperature 205 of the fuel cell power device 20 is a quantitative measure of a temperature associated with operation of the fuel cell power device 20, such as a coolant inlet or outlet temperature or another parameter. The temperature 205 ranges between a low temperature 206, e.g., ambient temperature, and a maximum temperature 207, such as may occur when the fuel cell power device 20 is operating at a maximum power output.

FIG. 3 graphically illustrates another performance characterization 250 for an embodiment of the fuel cell power device 20 that is described with reference to FIG. 1. The performance characterization 250 may be described in relation to the temperature 205 of the fuel cell power device 20 on the horizontal axis and membrane life 254 on the left vertical axis, with a non-linear temperature-membrane life relationship 256 being illustrated. The non-linear temperature-membrane life relationship 256 for the fuel cell power device 20 may occur as a result of system optimization, material selection, design trade-offs, etc. during product development that affect performance, durability, and robustness to achieve electric power targets.

The membrane life 254 may be a measure of an operating life of the membrane in the fuel cell power device 20 based on operating at a given temperature 205 of the fuel cell power device 20. The temperature 205 of the fuel cell device ranges from a minimum of 258 to a maximum of 260. The membrane life 254 of the fuel cell power device 20 ranges between a maximum life 264 and a minimum membrane life 262. The maximum membrane life 254 corresponds to a lower temperature 205 and the minimum membrane life 262 corresponds to a higher temperature 205.

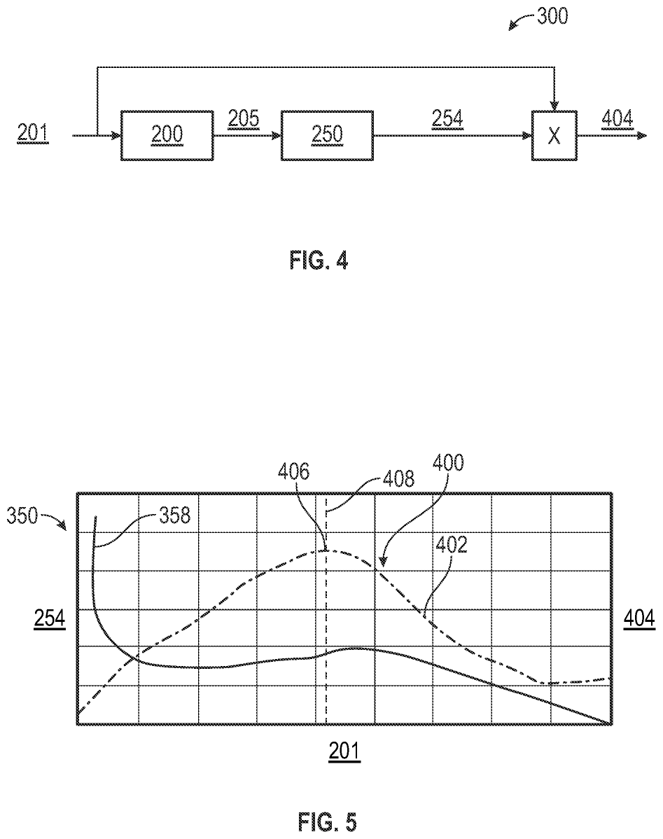

FIG. 4 graphically illustrates an approach 300 for determining a third performance characterization 350 (FIG. 5), such as electric power 201 to membrane life 254, and a fourth performance characterization 400 (FIG. 5), such as electric power 201 to membrane life energy 404 for an embodiment of the fuel cell power device 20 that is described with reference to FIG. 1. The third performance characterization 350 relates the first performance characterization 200 to the second performance characterization 250 and the fourth performance characterization 400 is derived from the third performance characterization 350. The third performance characterization 350 relates membrane life 254 to the electric power 201 generated by the fuel cell power device 20. As shown in FIG. 4, the approach 300 inputs a given electric power 201 into the first performance characterization 200 and outputs a corresponding temperature 205 for the given electric power 201 generated by the fuel cell power device 20. The corresponding temperature 205 is then input into the second performance characterization 250 which outputs a corresponding membrane life 254 for the fuel cell power device 20 at the given electric power 201.

Although the third and fourth performance characterizations utilize temperature as the main independent variable in this disclosure, the disclosure can be extended to any membrane life model that is based on other independent operating parameters, such as humidity, pressure, or stoichiometry. In particular, this disclosure relates independent operating parameters to power level in order to solve for an optimal membrane life power that maximizes life of the fuel cell power device. The optimal membrane life power associated with the maximum life can then be utilized as part of the hybridization control as will be discussed in greater detail below.

As shown in FIG. 5, the third performance characterization 350 can then be expressed by the given electric power 201 (bottom axis in kilowatts) in terms of the membrane life 254 (left vertical axis in hours) for the fuel cell power device 20. The relationship of the third performance characterization 350 is nonlinear and represented by line 358 illustrated in FIG. 5.

The approach 300 of FIG. 4 then multiples the electric power 201 by the membrane life 254 to determine the fourth performance characterization 400 which provides a membrane life energy 404 for the fuel cell power device 20 in terms of the given electric power 201. The membrane left energy 404 defines an amount of energy that the fuel cell power device 20 can generate over its lifetime when operated at the given electric power 201. In the illustrated example, the membrane life energy 404 is represented in kilowatt hours (kWh) along the right vertical axis in a non-linear relationship with line 402 with the given electric power 201 in kW along the bottom axis of FIG. 5.

Furthermore, as shown in FIG. 5, the performance characterization 400 represented by line 402 illustrating the relationship between the given electric power 201 and the membrane life energy 404. The membrane life energy 404 includes a maximum value 406 or optimal membrane life energy that corresponds to an optimal membrane life power at line 408 for the fuel cell power device 20 over its lifetime. The maximum value 406 for the membrane life energy 404 corresponds to an optimal membrane life power (line 408) for the electric power 201 generated by the fuel cell power device 20 that will produce the greatest amount of lifetime energy generation by fuel cell power device 20.

FIG. 6 illustrates a method 500 of operating the fuel cell power device 20. In one example, the method 500 determines if the application power requested for the fuel cell power device 20 is less than the optimal membrane life power 408 for the fuel cell power device 20 (Block 502) as described above. In one example, the application power requested can be analyzed over a predetermined period of time or determined based on a specific use of the fuel cell power device 20, such as in a passenger car, heavy equipment, or a stationary device. The analysis can learn when the application power requested varies based on operation to further optimize the power generation and when to operate between the optimal membrane life power and a second power. The method 500 can also determine the application power requested by creating an average application power requested by the system 100 over a predetermined period of time by monitoring the application power requested over a predetermined length of time.

When the application power requested, such as an average application power requested, is less than the optimal membrane life power 408, the fuel cell power device 20 operates between operating at the optimal membrane life power level for the fuel cell power device 20 and a lower power bound (Block 504). When operating at the optimal membrane life power level, the fuel cell power device 20 can operate at a first power that is within a predetermined range that includes the optimal membrane life or at a first power that is at the optimal membrane life. In the illustrated example, the lower power bound is below the application power requested and may include a minimum power of operation for the fuel cell power device 20 or a zero-output power for the fuel cell power device 20. Furthermore, the lower power bound can be selected based on thermal constraints, such as ambient temperatures which may change a value for the lower power bound.

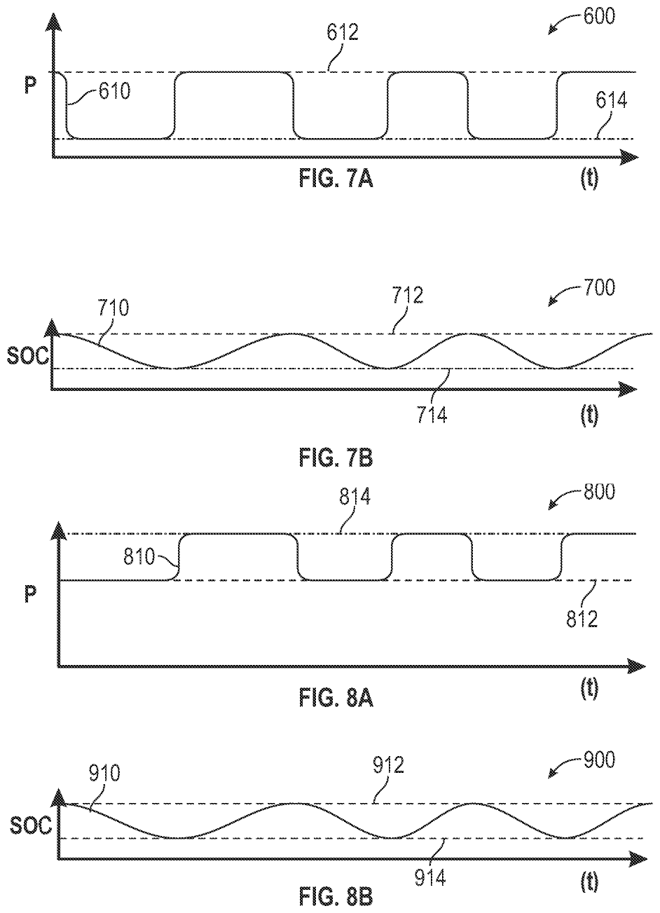

FIG. 7A is a graphical illustration 600 of variations in power P generated by the fuel cell power device 20 over time (t) during operation of the torque generation system 100. FIG. 7A illustrates the use case when the application power requested is less than the optimal membrane life power of the fuel cell power device 20. In particular, line 610 illustrates variations in the power output P over time (t) of the fuel cell power device 20 as it operates between generating power at the optimal membrane life power 408 at line 612 and the lower power bound at line 614. In the illustrated example, the lower power bound is less than the application power requested. Also, because the optimal membrane life power 408 is greater than the application power requested, the excess power generated when operating at the optimal membrane life power 408 is directed to charge the high-voltage battery 10.

FIG. 7B is a graphical illustration 700 of variations in a percentage of a state of charge (“SOC”) of the high-voltage battery 10 shown by line 710 over time (t) during charging by fuel cell power device 20 and depletion by the torque generation system 100. To improve an operating lifespan of the high-voltage battery 10, the high-voltage battery 10 operates between a predetermined SOC upper bound 712 and a predetermined SOC lower power bound 714. In one example, the SOC upper bound 712 corresponds to an 80% SOC and the SOC lower power bound 714 corresponds to a 20% SOC. An operating time for the high-voltage battery 10 depends on a relative capacity of the high-voltage battery 10 in relation to the application power requested.

Once a SOC of the high-voltage battery 10 reaches the upper bound 712 as shown by line 710, the fuel cell power device 20 reduces its power generation to the lower power bound 614 until the SOC of the high-voltage battery 10 reaches the lower power bound 714. When the SOC of the high-voltage battery 10 reaches the lower power bound 714, the fuel cell power device 20 is then directed to operate at the optimal membrane life power 612 until the SOC reaches the upper bound 712, or the application power requested has been reduced to zero. Also, the fuel cell power device 20 switches between the upper power bound 612 and the lower power bound 614 when the SOC is at the SOC upper or lower bound to avoid cycling of the fuel cell power device 20.

Additionally, the high-voltage battery 10 can be charged by an external power source other than the fuel cell power device 20, such as a charge station, when a vehicle associated with the fuel cell power device 20 is not being actively used. One feature of utilizing a charge source other than the fuel cell power device 20, is that the amount of power used to charge the high-voltage battery 10 does not detract from the optimal membrane life energy 404 of the high-voltage battery 10. Therefore, the use of the external power source increases the overall lifespan of the torque generating system 100 by sharing the power generation with another source instead of just the fuel cell power device 20. The external power source can also charge the high-voltage battery 10 at an optimal power level to reduce charge time.

FIG. 8A is a graphical illustration 800 of variations in the power P generated by the fuel cell power device 20 over time (t) during operation of the torque generation system 100. FIG. 8A illustrates the use case when the application power requested is greater than the optimal membrane life power (Block 506). In particular, line 810 illustrates variations in the power output P over time (t) of the fuel cell power device 20 as it operates between generating power at the optimal membrane life power at line 812 and an upper power bound at line 814 that is greater than the application power requested (Block 508). In the illustrated example, the upper power bound 814 can be selected based on thermal constraints, such as ambient temperatures which may change a value for the upper power bound 814.

FIG. 8B is a graphical illustration 900 of variations in a percentage of a state of charge (“SOC”) of the high-voltage battery 10 shown by line 810 over time (t) during charging by fuel cell power device 20 and depletion by the torque generation system 100. To improve the operating lifespan of the high-voltage battery 10, the high-voltage battery 10 operates between a predetermined SOC upper bound 912 and a predetermined SOC lower power bound 814. In one example, the SOC upper bound 912 corresponds to an 80% SOC and the SOC lower power bound 914 corresponds to a 20% SOC. Once a SOC of the high-voltage battery 10 reaches the upper bound 912 as shown by line 910, the fuel cell power device 20 reduces its power generation to the optimal membrane life power at line 812 until the SOC of the high-voltage battery 10 reaches the lower power bound 914 of the SOC. When the SOC of the high-voltage battery 10 reaches the lower power bound 914, the fuel cell power device 20 is then directed to operate at the upper power bound 814 until the SOC reaches the upper bound 912, or the application power requested reduced to zero.

Furthermore, variations in power output of the fuel cell power device 20 are controlled to a rate that reduces potential damage to the electrodes. Also, the method 500 can return to Block 502 to determine if the application power has changed to determine if the method should proceed to Blocks 504 or 506. If the high-voltage battery 10 is no longer able to provide power, the fuel cell power device 20 can vary from optimal membrane life energy.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characterization) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed, but will include embodiments falling within the scope thereof.

1. A hybrid system comprising:
a high-voltage bus;
a high-voltage battery electrically connected to the high-voltage bus;
a fuel cell power device electrically connected to the high-voltage bus;
a drive unit electrically connected to the high-voltage bus; and
a controller electrically connected to the drive unit, the fuel cell power device, and the high-voltage battery; the controller configured to:
identify an application power request for the drive unit;
determine a relationship between the application power request and an optimal membrane life power for the fuel cell power device; and
direct the fuel cell power device to operate between a first power associated with the optimal membrane life power and a second power, wherein the application power request is at a power level between the optimal membrane life power and the second power.

2. The hybrid system of claim 1, wherein the first power is withing a predetermined range that includes the optimal membrane life power and the optimal membrane life power is determined based on a function of an electric power generated by the fuel cell power device and membrane lifetime energy of the fuel cell power device.

3. The hybrid system of claim 2, wherein the optimal membrane life power corresponds to an optimal electric power that produces an optimal membrane lifetime energy.

4. The hybrid system of claim 3, wherein the optimal membrane lifetime energy is determined based on a relationship between membrane life and the electric power.

5. The hybrid system of claim 4, wherein the membrane lifetime energy is determined by multiplying the membrane life of the fuel cell power device by the electric power generated at the membrane life.

6. The hybrid system of claim 4, wherein the relationship between the membrane lifetime energy and the electric power is based on a first relationship between a coolant temperature of the fuel cell power device and the electric power generated by the fuel cell power device and a second relationship between the membrane life of the fuel cell power device and the coolant temperature of the fuel cell power device.

7. The hybrid system of claim 1, wherein the application power request is determined based on an average power usage for the hybrid system over a predetermined period of time.

8. The hybrid system of claim 1, wherein the controller is configured to direct fuel cell output power to the high-voltage battery when operating at the optimal membrane life power with the application power request being less than the optimal membrane life power and the second power includes one of a minimum power generated or zero-power power generated by the fuel cell power device.

9. The hybrid system of claim 1, wherein the controller is configured to direct fuel cell output power to the high-voltage battery when operating at the second power with the second power being greater than the application power request.

10. A method of operating a hybrid system, the method comprising:
identifying an application power request for the hybrid system, wherein the hybrid system includes a high-voltage battery, a fuel cell power device, and an electric drive unit each electrically connected to a high-voltage bus;
determining a relationship between the application power request and an optimal membrane life power for the fuel cell power device; and
directing the fuel cell power device to operate between a first power associated with the optimal membrane life power and a second power, wherein the application power request is at a power level between the optimal membrane life power and the second power.

11. The method of claim 10, wherein the first power is withing a predetermined range that includes the optimal membrane life power and the optimal membrane life power is determined based on a function of an electric power generated by the fuel cell power device and a membrane lifetime energy of the fuel cell power device.

12. The method of claim 11, wherein the optimal membrane life power corresponds to an optimal electric power that produces a maximum membrane life energy and the membrane lifetime energy is determined based on a relationship between the electric power and membrane life

13. The method of claim 12, wherein the application power request is analyzed over a period of time to determine when to operate between the optimal membrane life power and the second power.

14. The method of claim 10, including directing a fuel cell generated power to the high-voltage battery when the application power request is less than the optimal membrane life power and the second power includes one of a minimum power generated or zero-power power generated by the fuel cell power device.

15. The method of claim 10, including directing a fuel cell generated power to the high-voltage battery when the application power request is greater than the optimal membrane life power and the second power includes one of a minimum power generated or zero-power power generated by the fuel cell power device.

16. The method of claim 10, wherein a time to operate between the optimal membrane life power and the second power is determined based on a battery capacity in relation to the application power request.

17. The method of claim 10, including charging the high-voltage battery with an external power source.

18. A method of operating a hybrid system, the method comprising:
identifying an application power request for the hybrid system, wherein the hybrid system includes a high-voltage battery, a fuel cell power device, and an electric drive unit each electrically connected to a high-voltage bus;
determining a relationship between the application power request and an optimal membrane life power for the fuel cell power device, wherein the optimal membrane life power is determined based on a function of an electric power generated by the fuel cell power device and membrane lifetime energy of the fuel cell power device; and
directing the fuel cell power device to operate between a first power associated with the optimal membrane life power and a second power, wherein the application power request is at a power level between the optimal membrane life power and the second power; and
directing excess power generated by the fuel cell power device to the high-voltage battery

19. The method of claim 18, wherein the first power is withing a predetermined range that includes the optimal membrane life power and the optimal membrane life power is determined based on a function of the electric power generated by the fuel cell power device and the membrane lifetime energy of the fuel cell power device.

20. The method of claim 18, wherein a time to operate between the optimal membrane life power and the second power is determined based on a battery capacity in relation to the application power request.
